(19) United States
(12) Patent Application Publication
(10) Pub. No.: US 2017/0367352 A1
(43) Pub. Date: Dec. 28, 2017

(54) Baking Pan for Shaping Cakes and Method of Using It

(71) Applicant: Andrew Owens, Brooklyn, TX (US)

(72) Inventor: Andrew Owens, Brooklyn, TX (US)

(21) Appl. No.: 15/193,869

(22) Filed: Jun. 27, 2016

(51) Int. Cl. A21B 3/13; A47J 37/01

(52) U.S. Cl. CPC A21B 3/137; A47J 37/01

(57) ABSTRACT

A baking pan for baking cup cakes that includes a base baking pan with baking units having a size and dimension and a top baking pan with baking units having a different size and dimension. The base baking pan and the top baking pan couple and align together and when coupled and aligned produce a first cup cake having a shape of a cup and a second cup cake having a shape of a cylinder. As such, the cup cakes are baked in two separate pieces producing a bottom cup shaped cup cake and a top cylinder shaped cup cake.

### TECHNICAL FIELD

The present invention relates to a baking pan for baking one or more cakes of different size and shapes and more particularly to a baking pan for baking one or more cup cakes with each cup cake baked in two pieces with one cup cake shaped like a cup and another shaped like a cup interior.

### BACKGROUND

Cup cakes are traditionally made by baking cake mix in the form of a small cake with a rounded cake top. This process of baking cup cakes is traditional, antiquated, and lacks creativity. Furthermore, toppings for cakes have become abundant. Consumers tend to put pretty much anything on cup cakes, e.g. ice cream, gummy bears, frostings, chocolate, whip cream, fruit, nuts, caramel, cookies, etc. In this regard, the traditional cup cake considering its size is limited as to what toppings can be applied or the amount that can be applied. In addition, some consumers may prefer more cake than toppings and some consumers may prefer more toppings than cake or a customer may prefer both.

As such, there is a need for a cup cake and a mechanism for making such that can produce multi-shaped cup cake pieces wherein the pieces can be formed to accommodate the toppings consumers desire.

### SUMMARY OF THE INVENTION

It will be readily apparent from the foregoing that a need exist in the art to produce a cup cake having separable pieces with different size and shapes. It is therefore a primary objective of the invention to provide a baking pan for baking at least one cup cake having a bottom piece and a top piece of differing size and shape.

To achieve the objectives, the invention is directed to a baking pan that includes a top and bottom pan with baking units formed therein and with each baking unit defining a unique size and shape, the unique size and shape defining in one baking unit a cup shape and the other a solid cylinder shape.

the invention is also directed to a method of making a cup cake by use of the baking pan described. After the cup cake is baked in separate pieces, the cup cake pieces can be filled with or spread with cup cake toppings.

### BRIEF DESCRIPTION OF THE DRAWINGS

FIG. 1A illustrates a top view of base cup cake pan according to a preferred embodiment of the invention.

FIG. 1B illustrates a top view of top cup cake pan according to a preferred embodiment of the invention.

FIG. 2 illustrates an open side view of a cup cake baking pan assembly according to a preferred embodiment of the invention.

FIG. 3 is a closed side view of a cup cake baking pan assembly according to a preferred embodiment of the invention.

### DETAILED DESCRIPTION OF THE PRESENTLY PREFERRED EMBODIMENTS

A preferred embodiment of the present invention will now be set forth in detail with reference to the drawings, in which like components are designated by like reference numerals thereon.

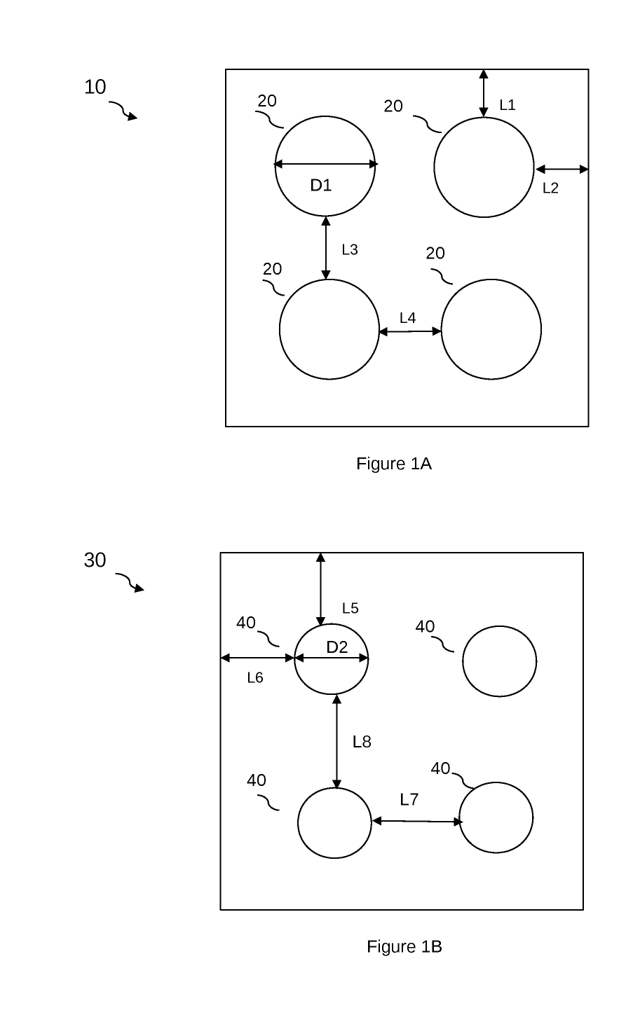

Referring to FIG. 1A and 1B, a top view of a base body 10 that includes four sides and at least one baking unit 20 formed within the base body 10 and a top view of a top body 30 that includes four sides with at least one baking unit 40 formed within the top body 30 is illustrated. Base body 10 and top body 30 when coupled form a baking pan for baking cup cakes with each cup cake baked in two pieces comprising a top and a bottom of differing size and shape. The baking pan can be made out of any material which will withstand the baking process, which typically involves a temperature of 400 degrees or more for one hour or more, and not taint the cakes; such materials include FDA-approved plastics, metals, foils and baking papers. The finish should be suitable for the normal release of the baked cake.

In this embodiment, the illustration shows four baking units 20 formed in the base body 10 with each baking unit 20 formed within the body body 10 with a length L1, L2, e.g. 10/16 of an inch, from each side of the base body 10 and each baking unit 20 separated by a length L3, L4, e.g. of 1 inch. In addition, the baking units 20 may have a diameter D1 of 3 inches, as an example. The example dimensions essentially provide for a base body with each side 8¼ inches. Although, it should be understood that these sizes can be easily varied. Furthermore, the number of baking units can be varied and the shapes of the baking units can be of different shapes.

Further to this embodiment, the illustration shows four baking units 40 formed within the top body 30 with a length L5, L6, e.g. 1 inch, from a each side of the top body 40 and each baking unit 40 separated by a length L7, L8, e.g. of 1 12/16 inches, as an example. In addition, the baking units 40 may have a diameter D2 of 2¼ inches, as an example. The example dimensions essentially provide for a top body with each side 8¼ inches. Although, it should be understood that these sizes can be easily varied. Furthermore, the number of baking units can be varied and the shapes of the baking units can be of different shapes.

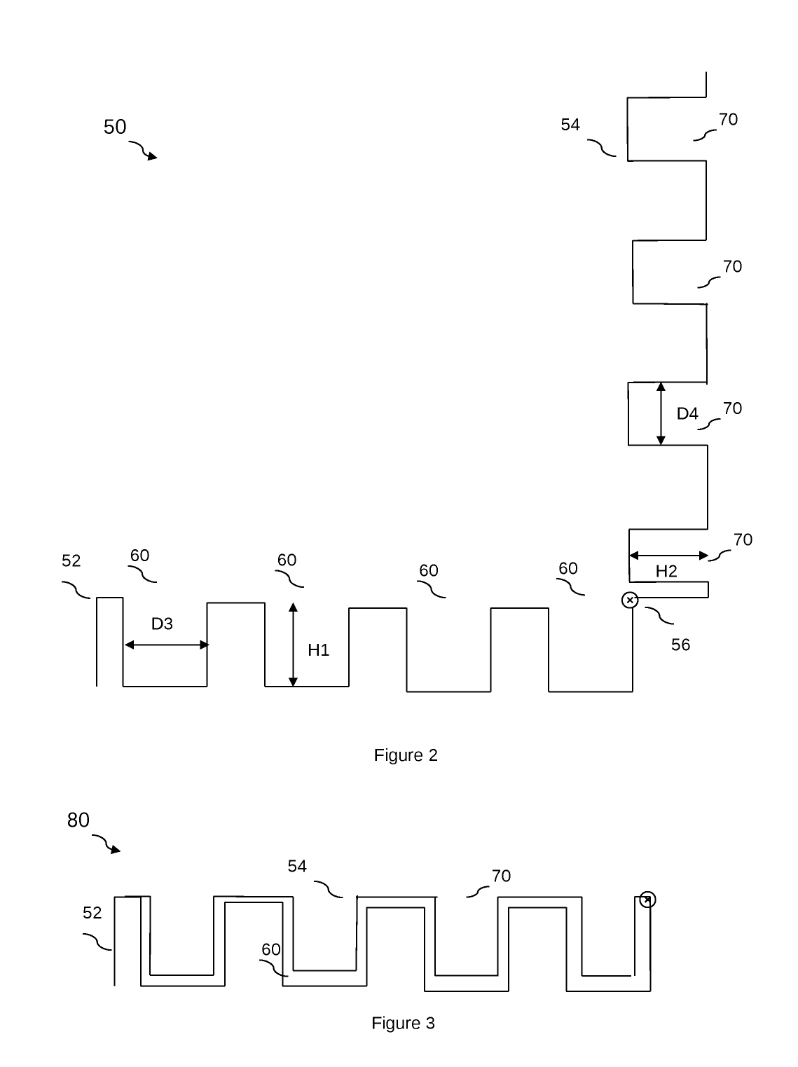

Referring now to FIGS. 2, a cut-away view of an assembled baking pan 50 is illustrated. Baking pan 50 includes a base body 52 that includes at least one baking unit 60 formed within the base body 52 and a top body 54 that includes at least one baking unit 70 formed within the top body 54 is illustrated. The base body 52 includes each baking unit 60 having a diameter D3. In addition, the base body 52 includes a hinge 56 coupling base body 52 with top body 54. The top body 54 includes each baking unit 70 having a diameter D4. Furthermore, each baking unit 60 includes a height H1 and each baking unit 70 includes a height H2 and the heights are of differing heights with H1 greater than H2.

It should be understood that the illustration is an alternative embodiment that although adheres to the fundamental principals of the measurements described in FIGS. 1A and 1B, the illustration is illustrative of a baking pan with more baking units 60,70. As such, although the same dimensions do not apply the necessary and similar dimension could be easily ascertained and applied to the baking pan pan illustrated or any other baking pan of differing size and dimensions. It should also be understood the shapes illustrated are not limiting in any way. The shapes of the baking units 60,70 can be of any form.

Referring now to FIG. 3, baking pan 80 is illustrated that shows the assembled baking pan that includes base body 52 and top body 54 with top body 52 rotated about the hinge 56 to align baking units 60 and 70, effectively forming a dual chamber baking apparatus for producing cup cakes shaped as cup and the other as cup cake center.

Thus, While there have been shown and described and pointed out fundamental novel features of the invention as applied to a preferred embodiment thereof, it Will be under stood that various omissions and substitutions and changes in the form and details of the devices illustrated, and in their operation, may be made by those skilled in the art Without departing from the spirit of the invention. For example, it is expressly intended that all combinations of those elements and/or method steps Which perform substantially the same function in substantially the same Way to achieve the same results are Within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. A baking pan for baking a multi-shaped cup cake in separate pieces comprising:
a base body that includes four sides and a first side with a hinge mounted to the base body and at least one cup cake baking unit formed in the base body, each of the at least one baking unit define a shape in the form of a cavity and having a diameter and height;
a top body that includes four sides with one side coupled to the hinge of the first side of the base body and further includes at least one cup cake baking unit formed in the top body, each of the at least one cup cake baking unit define a shape in the form of a cavity and having a diameter and height slightly less than the diameter and height of the cavity of the cup cake bottom; and
the top body movable about the hinge to rotate to a position where the four sides of the top body and the base body meet and the at least one cup cake interior baking unit rests within the at least one base body baking unit.

2. The baking pan of claim 1, wherein the at least one cup cake bottom baking unit has a diameter of approximately four inches.

3. The baking pan of claim 1, wherein the at least one cup cake interior baking unit has a diameter of approximately two and half inches.

4. A method of making at least one cup cake, each of different shape, the method comprising:
providing a baking pan having a a base body that includes four sides and a first side with a hinge mounted to the base body and at least one cup cake bottom baking unit formed in the base body, each of the at least one baking unit define a shape in the form of a cavity and having a diameter and height; a top body that includes four sides with one side coupled to the hinge of the first side of the base body and further includes at least one cup cake interior baking unit formed in the top body, each of the at least one cake cake interior baking unit define a shape in the form of a cavity and having a diameter and height slightly less than the diameter and height of the cavity of the cup cake bottom;
introducing a cake mix from which the cup cakes are to be made into the at least one cup cake bottom baking unit;
moving the top body about the hinge to rotate to a position where the four sides of the top body and the base body meet and the at least one cup cake interior baking unit rests within the at least one cup cake bottom baking unit; and
introducing a cake mix from which the cup cakes are to be made into the at least one cup cake interior baking unit;
baking the cake mix in the at least one cup cake bottom and interior baking unit to make separate cup cakes with different shapes; and
and removing the cup cakes from the at least one baking unit.

5. The method of claim 4 wherein each wherein the at least one cup cake bottom baking unit has a diameter of approximately four inches.

6. The method of claim 4 wherein the at least one cup cake interior baking unit has a diameter of approximately two and half inches.
